(19) United States
(12) Patent Application Publication
(10) Pub. No.: US 2025/0212878 A1
(43) Pub. Date: Jul. 3, 2025

(54) BIOBASED LARVICIDES

(71) Applicant: Discovery Purchaser Corporation, Wilmington, DE (US)

(72) Inventors: Johan KIJLSTRA, Odenthal (DE); Arunas Jonas DAMIJONAITIS, Chapel Hill, NC (US)

(21) Appl. No.: 18/867,705

(22) PCT Filed: May 25, 2023
(86) PCT No.: PCT/EP2023/064023

§ 371 Date: Nov. 20, 2024

(30) Foreign Application Priority Data
May 25, 2022 (EP) 22175491.4

(51) Int. Cl. A01N 43/16; A01N 25/30; A01P 7/04

(52) U.S. Cl. CPC A01N 43/16; A01N 25/30; A01P 7/04

(57) ABSTRACT

The invention relates to a composition comprising a cationic polysaccharide compound selected from the group consisting of cationic fructan or cationic glucan, an anionic surfactant and a compatibilizer. The invention also related to the use of said cationic polysaccharide compound against insect pests belonging to the family Culicidae, particularly against mosquito larvae.

### BACKGROUND

The invention relates to a composition comprising a cationic polysaccharide compound selected from the group consisting of cationic fructan or cationic glucan, an anionic surfactant and a compatibilizer. The invention also related to the use of said cationic polysaccharide compound against insect pests belonging to the family Culicidae, particularly against mosquito larvae.

During the last decades many different technologies were developed to control mosquitoes. These vectors transmit many different severe or even deadly diseases (malaria, dengue, chikungunya, filariasis, yellow fever, Zika virus and other arboviruses) when adult individuals “bite” humans. Mosquito larvicides target the larval stage of the mosquito, allowing for alternative (bio-based) treatments that are less rapid in killing the adult animals, but effective in preventing the development of adult mosquitoes and thus, transmission of diseases. Larviciding is considered as a useful supplement to core vector intervention methods (as impregnated bed nets and long-lasting indoor sprays), especially in those locations, where vectors tend to breed in permanent or semi-permanent water bodies that can be readily identified and accessed (Larval Source Management, WHO). Hence, especially in urban areas where larval habitats are man-made and easy to identify and treat, larviciding can be a useful tool in a Integrated Vector Management (IVM) approach.

Oils and surface agents, synthetic organic chemicals, bacterial larvicides, spinosyns and insect growth regulators are the five well-known main groups of larvicides. Application target, product safety, stability, efficacy, potency, residuality, cost-effectiveness are some criteria for the selection of specific substances from these classes for use.

One of the oldest forms of larval control is the use of oils (e.g. petroleum distillates) and monomolecular surface films (MMFs, e.g. isostearyl alcohol), which act by disrupting the surface tension, frustrating the larval siphonal respiration process at the water interface, causing suffocation and mortality. From a resistance management point of view, these approaches are of interest since mosquitos cannot develop resistance to oil. Disadvantages of oils and MMFs are lack of cost-effectiveness for large-scale treatment and limited residuality, especially under impact of wind or absorption by vegetation, these products.

For treatment of potable water drums and containers, more modem products like synthetic actives (e.g. Temephos) and biorational products (e.g. Bacillus thuringiensis subsp. israelensis or BTi) are offered successfully in the marketplace. However, the number of commercially available and effective mosquito larvicides is limited, while each of these solutions also do have their own specific disadvantages, e.g. limited residuality (frequent reapplication may be required), narrow application window, harmfulness to non-target organisms, toxicity to humans or possible development of resistance.

In light of the prior art it was an objective of the present invention to provide a new, preferably bio-based approach for larval control against larvae from disease transmitting mosquitos. Solutions which are cost-effective, easy to formulate and biological efficacious while having the potential as a new resistance management tool.

WO 2020/025592 describes the use of specific polysaccharide compounds as fungicides.

WO 2017/177342 discloses glycogen or phytoglycogen, that are functionalized with a quaternary ammonium compound, and which have antifungal activity.

EP 3 315 593 refers to dishwashing detergent compositions comprising at least one cationic derivate of a polysaccharide.

Cationic fructan compounds as e.g. described in WO 1998/14482 A1 are known to be useful as auxiliaries in papermaking, water treatment, sludge treatment, in cosmetics, as disinfectants, hair conditioners, flocculants, shale inhibitors, corrosion inhibitors, emulsifiers, adhesive textile auxiliaries, or as additives in building, ceramics or plastics.

Lowe et al. (Synthesis and Solution Properties of Zwitterionic Polymers, Chem. Re. 2002, 102, 4177-4189) describe in general polyzwitterions (zwitterionic polymers), preparation and uses of such compounds.

However, environmental science solutions based on cationic fructan compounds for vector and professional pest management control have not yet been described.

It is surprising that cationic polysaccharide compounds show both fungicidal and larvicidal properties, since biological targets and type of applications differ strongly for both type of applications (contact efficacy on treated leaves for disease control versus oral uptake by mosquito larvae for larviciding).

Even more surprising is the discovery that larvicidal efficacy of polysaccharide compounds, can be enhanced through combination with anionic surfactants. Having no intrinsic larvicidal effect itself, the anionic surfactant boosts not only the level of bio efficacy but also the speed of action. This provides opportunities for a new larvicide solution with a new mode of action, giving good biocontrol at very low and commercially viable application rates.

The present invention also includes a formulation concept to overcome the physical incompatibility between cationic polymer and anionic surfactant to facilitate easy & effective application for controlling larvae of insects, such as larvae of Culicidae. This concept involves the use of a third component, an amphoteric biopolymer, which builds supramolecular complexes with both other components.

It has now been discovered that these water-soluble cationic glucans and fructans, especially inulins show larvicidal properties against insect pests, especially belonging to the family Culicidae. This was especially observed when such a compound is applied and dissolved in aqueous media in which the larvae live.

### SUMMARY

A first aspect of the present invention refers to a composition comprising
a) at least one cationic polysaccharide compound selected from the group consisting of a cationic fructan or cationic glucan, especially preferred an inulin, which contains, per monosaccharide unit, on average at least 0.1 cationic group (degree of substitution (DS)) of the formula (I):

*-A-N⁺R¹R²R³; or
of the formula (II)

*—(C(═NR⁴)—NR¹R²R³)⁺
wherein:
*- represents the bond between an atom of the polysaccharide compound of the cationic polysaccharide compound and the cationic group of formula (I) or (II), respectively;
A in formula (I) represents a straight-chain or branched C₂-C₆ alkylene group which is optionally preceded by a carbonyl group (C(O)) or optionally interrupted by one or two oxygen atoms or imino or alkylimino groups and optionally substituted by one or two hydroxy groups or amine groups or a carboxyl or carbamoyl group;
R¹ and R² in formula (I) or in formula (II), respectively, each represent independently from each other hydrogen methyl, carboxymethyl, phosphonomethyl, ethyl, hydroxyethyl, propyl, isopropyl, allyl, hydroxypropyl or dihydroxypropyl or, together with the nitrogen atom, form a pyrrolidino, piperidino, piperazino, N′-alkylpiperazino, N′-(hydroxyalkyl)piperazino, N′-(aminoalkyl)piperazino, morpholino or hexamethyleneamino group;
R³ in formula (I) or in formula (II), respectively, represents hydrogen, C₁-C₁₈ alkyl, C₃-C₁₈ alkenyl, alkynyl or cycloalkyl (for clarification's sake: C₃-C₁₈ alkenyl, C₃-C₁₈ alkynyl or C₃-C₁₈ cycloalkyl), C₄-C₁₈ cycloalkyl-alkyl or C₇-C₁₈ aralkyl; or
R³ in formula (I) represents a group of the formula -A′-Fruc, wherein A′ represents a straight-chain or branched C₂-C₆ alkylene group which is optionally preceded by a carbonyl group or optionally interrupted by one or two oxygen atoms or imino or alkylimino groups and optionally substituted by one or two hydroxy groups or amine groups or a carboxyl or carbamoyl group; or A′ represents a direct bond to Fruc wherein Fruc represents a fructan residue bonded via oxygen (i.e. the hydrogen of an —OH group of the fructan is substituted by A′); and
R⁴ in formula (II) represents hydrogen, methyl, ethyl, hydroxyethyl, hydroxypropyl or dihydroxypropyl; where the amine nitrogen atoms can be uncharged or protonated or quarternized with methyl, ethyl, hydroxyethyl, hydroxypropyl or dihydroxypropyl;
and wherein the polysaccharide compound has a solubility in water of at least 20 wt-% at a temperature of 25° C.;
b) an anionic surfactant; and
c) compatibilizer selected from the group consisting of amphoteric polymers or polyzwitterions.

A second aspect refers to the use of at least one cationic polysaccharide compound selected from the group consisting of cationic fructan or cationic glucan compound which contains, per monosaccharide unit, on average at least 0.1 cationic group of the formula (I):

*-A-N⁺R¹R²R³; or
of the formula (II)

*—(C(═NR⁴)—NR¹R²R³)⁺
wherein *-, A, R¹, R², R³, and R⁴ are as defined in claim 1 and wherein the polysaccharide compound has a solubility in water of at least 20 wt-% at a temperature of 25° C.;
as larvicide against insect pests belonging to the family Culicidae.

Embodiment 1 refers to a composition according to aspect 1 or use according to aspect 2, wherein the fructan compound is inulin.

Embodiment 2 refers to a composition or use according to any one of the preceding aspects or embodiments, wherein R¹ and R² in formula (I) or formula (II), respectively, each represent methyl or ethyl.

Embodiment 3 refers to a composition or use according to any one of the preceding aspects or embodiments wherein R¹ and R² and R³ in formula (I) represent methyl.

Embodiment 4 refers to a composition or use according to any one of the preceding aspects or embodiments, wherein A in formula (I) represents a C₂-C₆ alkylene group which is optionally substituted by a hydroxy group.

Embodiment 5 refers to a composition or use according to any one of the preceding aspects or embodiments, wherein A in formula (I) represents ethylene.

Embodiment 6 refers to a composition or use according to any one of the preceding aspects or embodiments, wherein A in formula (I) represents (1,3)-2-hydroxy-propylene.

Embodiment 7 refers to a composition or use according to any one of the preceding aspects or embodiments, wherein A is bonded to an oxygen atom of the monosaccharide unit.

Embodiment 8 refers to a composition or use according to any one of the preceding aspects or embodiments, wherein the fructan or glucan compound contains, per monosaccharide unit, on average from 0.1 to 2.5, more preferably on average from 0.2 to 2.0 and especially preferred from 0.35 to 1.5 cationic group.

Embodiment 9 refers to a composition or use according to any one of the preceding aspects or embodiments, wherein the polysaccharide compound has a degree of polymerization from 3 to 1000, preferably from 3 to 60 and most preferably from 3 to 15 monosaccharide units.

Embodiment 10 refers to a composition or use according to any one of the preceding aspects or embodiments, wherein said cationic polysaccharide compound is a fructan.

Embodiment 11 refers to a composition or use according to any one of the preceding aspects or embodiments, wherein said cationic polysaccharide compound is an inulin.

Embodiment 12 refers to a composition or use according to any one of the preceding aspects or embodiments, wherein said cationic polysaccharide compound is a glucan.

Embodiment 13 refers to a composition according to aspect 1 and any one of the preceding embodiments, wherein said anionic surfactant is selected from the group consisting of alkylsulphonates, arylsulphonates, alkylarylsulphonates, aryl ether sulphonates, lignosulphonates, alkyl sulphates, alkyl ether sulphates, sulphosuccinates, aliphatic and aromatic phosphate esters, alkoxylated phosphate esters, alkylcarboxylates, polycarboxylates, and salts of any of the foregoing.

Embodiment 14 refers to a composition according to aspect 1 and any one of the preceding embodiments, wherein said anionic surfactant is a sodium dioctyl sulphosuccinate.

Embodiment 15 refers to a composition according to aspect 1 and any one of the preceding embodiments, wherein said compatibilizer is selected from the group of amphoteric polymers or polyzwitterions, preferably wherein said compatibilizer is hydrolyzed collagen.

A third aspect refers to the use of at least one cationic polysaccharide compound as described in aspect 1 and any one of the preceding embodiments to curatively or preventively control larvae of insect pests, preferably belonging to the family Culicidae, more preferably of the subfamily Anophelinae and Culicinae.

### Definitions

The term “a” as used herein refers to “one (1) or more (more than 1)”.

The term “alkylene” as used herein refers to an alkane which is derived by removal of two hydrogen atoms from different carbon atoms. It is a strait or branched saturated carbohydrate moieties. In case of A as defined herein, the alkylene group has a bond to an atom of a polysaccharide on the one hand and a bond to the nitrogen of a quaternary ammonium group on the other hand. Thus, if an alkylene group is a C₂ alkylene group, the group would have the formula —CH₂—CH₂— (e.g. polysaccharide-CH₂—CH₂—N⁺R¹R²R³).

The term “anionic surfactant” as used herein refers to organic compounds with a no-polar part (aliphatic chain) and as a polar part one or more negatively charged groups. Usually, the negatively charged group is a carboxylate (—COO⁻), sulfonate (—SO₃⁻) or sulfate (—SO₄²⁻) group. Non limiting examples for anionic surfactants as used in this invention are alkylsulphonates, arylsulphonates, alkylarylsulphonates, aryl ether sulphonates, lignosulphonates, alkyl sulphates, alkyl ether sulphates, sulphosuccinates, aliphatic and aromatic phosphate esters, alkoxylated phosphate esters, alkylcarboxylates, such as fatty acids, and polycarboxylates; in each case usually as salts of polyvalent cations, preferably alkali metal salts or alkaline earth metal salts and even more preferably potassium, sodium and calcium salts. A fatty acid may be saturated or unsaturated. Usually, the number of carbons of an aliphatic chain is between 4 and 40. Most naturally occurring fatty acids have an unbranched chain of an even number of carbon atoms, from 4 to 28. Short-chain fatty acids (SCFA) are fatty acids with aliphatic tails of five or fewer carbons (e.g. butyric acid). Medium-chain fatty acids (MCFA) are fatty acids with aliphatic tails of 6 to 12 carbons, which can form medium-chain triglycerides. Long-chain fatty acids (LCFA) are fatty acids with aliphatic tails of 13 to 21 carbons. Very long chain fatty acids (VLCFA) are fatty acids with aliphatic tails of 22 or more carbons.

The term “between a and b” encompasses the borders a and b as well as all values within these borders.

The term “cationic” polysaccharide, fructan, glucan and/or inulin compound as used herein refers to such polysaccharide, fructan and/or glucan which comprise as a modification a cationic group of formula (I) or formula (II), respectively. Such a cationic group is either bond to a carbon-atom or an oxygen-atom of a polysaccharide. Usually, a cationic group is bound to the polysaccharide via an oxygen located at the position of one of the hydroxyl groups, i.e. formally, a hydrogen of a hydroxy group of a polysaccharide is replaced by a cationic group of formula (I) or formula (II), respectively. For example, a modified inulin which is particularly suitable for conversion to a cationic compound is a reduced dialdehyde-inulin. When dialdehyde-inulin is reduced, for example with hydrogen in the presence of a transition metal or with sodium borohydride, a polyol (poly-α-hydroxymethyl-α-[2-hydroxy-1-(hydroxymethyl)-ethoxy]ethylene oxide) is produced which contains a large number of primary hydroxy groups. These polyols can be converted to cationic compounds by methods known in the art. For example, dialdehyde inulin can be reductively aminated (in one step or two steps) using conventional reducing agents to produce the polyol indicated above wherein one or more hydroxymethyl groups are replaced by (substituted) aminomethyl groups, which may subsequently be quarternized. Amines to be used in the reductive amination include ammonia and primary C₁-C₆ alkylamines and alkylenediamines. The skilled person is aware of usual methods to introduce a cationic group of formula (I) or formula (II), respectively, into a polysaccharide. Cationic derivatives and their preparation are, e.g., described in WO 98/14482. Preparations of cationic starch ethers are, e.g., described in Carr et al., Starch 33 (1981) No. 9, p. 310-312.

Cationic polysaccharide (preferably fructan) compounds containing groups of formula -A-N⁺R¹R²R³, where “A” represents ethylene or 1,2-propylene, can, for example, be obtained by a reaction of the—optionally modified—polysaccharide (preferably fructan) with an ethyleneimine (aziridine) substituted in the correct manner on a nitrogen, or 1,2-propyleneimine or aminoethyl halide or 2-aminopropyl halide with a base in an organic solvent or preferably in water. When “A” represents 2-hydroxy-1,3-propylene, the reaction can be carried out with a glycidylamine (e.g. glycidyltrimethylammoniumchlorid) or a 3-halo-2-hydroxypropylamine or a corresponding ammonium salt, eg. 3-chloro-hydroxypropyl-trimethylammoniumchloride. When “A” contains a carbamoyl or carboxyl group as a substituent, the reaction can be carried out with a 2-dialkylamino-3-halopropionamide or 2-dialkylamino-3-halopropionic acid. When “A” represents 2-butenylene an unsubstituted or substituted 4-chloro-2-butenylamine can be used. Other suitable reagents are 2-chloropropyldimethylamine, N-(2-chloroethyl)-morpholine, 3-bromopropyl-trimethylammonium bromide, chloroethyldiethylamine, 4-chloro-1-methyl-piperidine, and the like.

The chemical modification of polysaccharides is usually characterized by the degree of substitution (DS) which equals the (average) number of hydroxy groups replaced by the substituent of the base unit in the chain. For cationic polysaccharides, DS can be calculated from the nitrogen content of the exhaustively washed modified product (to remove the not chemically-bound nitrogen) as determined by the Kjeldahl method. For modifications of glucans and fructans with glycidyltrimethylammoniumchlorid, the degree of substitution (DS) can be calculated from the nitrogen content N (in w %) according to the Kjeldahl-method after purification by Soxhlet extraction using the following formula DS=162*N/(14*100−151.5*N) where 162, 14 and 151.5 are the molar mass of the anhydroglucose/fructose unit, element N and the quaternary ammonium group, respectively (see also Kavaliauskaite et al, “Factors influencing production of cationic starches, Carbohydrate Polymers 73 (2008) 665-675).

The skilled person understands that the ratio between monosaccharide units of a cationic polysaccharide compound according to the invention and the cationic groups as described herein is a statistic value. The term “at least (e.g.) 0.1 cationic group” per monosaccharide unit means per ten monosaccharide unit of a cationic polysaccharide compound the cationic polysaccharide compound contains at least one cationic group as defined herein. For sake of completeness, “at least 0.1 cationic group” also encompasses compounds with more than 0.1 cationic groups per monosaccharide unit, e.g., in case of a cationic polysaccharide compound with less than ten monosaccharide units the factor will automatically be higher.

For example, a cationic polysaccharide compound composed of 5 monosaccharide units and one cationic group will have a ratio of 0.2; a cationic polysaccharide compound composed of 5 monosaccharide units and 2 cationic groups will have a ratio of 0.4; a cationic polysaccharide compound composed of 60 monosaccharide units requires the presence of at least six cationic groups. If twelve groups are present per 60 monosaccharide units, the ratio would be 0.2. The skilled person is also aware that the distribution of cationic groups in a cationic polysaccharide compound according to the invention may not be spatially regular.

The term “fructan” as used herein refers to polysaccharides composed of three or more monosaccharide units bound together by glycosidic linkages, wherein at least 50% of the monosaccharides are (anhydro)fructose-units. These fructans can have a polydisperse chain length distribution and can be straight-chain or branched. The term comprises fructans from various sources or processes. For example, fructans can be obtained directly from a vegetable or other source or can be modified, e.g., in that the average chain length has been modified (increased or reduced) by fractionation, enzymatic synthesis or hydrolysis. The fructans have an average chain length (=degree of polymerization, DP) of at least 3 up to about 1.000 polymerized mono-units, in particular from 3 up to about 60. Fructans with a short chain length are known as fructooligosaccharides. Usually, fructans are built up of fructose residues, normally with a sucrose unit (i.e. a glucose-fructose disaccharide) at what would otherwise be the reducing terminus of the polymer. Linkage normally occurs at one of the two primary hydroxyls (OH-1 or OH-6). The various types of fructans are defined by their linkage position of the fructose residues determine. The most relevant types of fructans are: inulin (fructosyl residues are linked by β-2,1-linkages); levan and phlein (in the latter two, the fructosyl residues are linked by β-2,6-linkages), fructans of the graminin type (containing both β-2,1-linkages and β-2,6-linkages), and the two more complex fructan types which are formed on a 6G-kestotriose backbone where elongations occur on both sides of the molecule: fructans of the neo-inulin type (predominant β-2,1-linkages) and fructans of the neo-levan type (predominant β-2,6-linkages).

Fractionation of fructans such as inulin can be achieved by, for example, low temperature crystallization (see WO 96/01849), separation by column chromatography (see WO 94/12541 A1), membrane filtration (see EP440074 A and EP-A-627490 A) or selective precipitation with an alcohol. Other fructans, such as long-chain fructans which, for example, are obtained on crystallization, fructans from which monosaccharides and disaccharides have been removed and fructans in which the chain length has been lengthened enzymatically, can also be converted to cationic compounds. Prior hydrolysis to obtain shorter fructans can be carried out, for example enzymatically (endoinulinase), chemically (water plus acid) or by heterogenous catalysis (acid ion exchange resin). Alternatively or additionally, crosslinked fructans can be used for producing cationic compounds.

The term “glucan” as used herein as used herein refers to polymers composed of three or more monosaccharide units bound together by glycosidic linkages, wherein at least 50% of the monosaccharides are (anhydro)glucose. In case a compound has the same numbers of fructose and glucose monosaccharides, such a compound is regarded as a fructan. Many beta-glucans are medically important. They represent a drug target for antifungal medications of the echinocandin class. The most relevant types of glucans are: dextran (α-1,6-glucan with α-1,3-branches), floridean starch (α-1,4- and α-1,6-glucan), glycogen (α-1,4- and α-1,6-glucan), pullulan (α-1,4- and α-1,6-glucan), starch (a mixture of amylose and amylopectin, both α-1,4- and α-1,6-glucans), cellulose (β-1,4-glucan), chrysolaminarin (β-1,3-glucan), curdlan (β-1,3-glucan), laminarin (β-1,3- and β-1,6-glucan), lentinan (a purified β-1,6:β-1,3-glucan from Lentinus edodes), lichenin (β-1,3- and β-1,4-glucan), oat beta-glucan (β-1,3- and β-1,4-glucan), pleuran (β-1,3- and β-1,6-glucan isolated from Pleurotus ostreatus), and Zymosan (β-1,3-glucan). Glucans can be modified similar modified as described above for the fructans (but glucans are used instead of fructans) or below under the definition for a “cationic” compound as used herein.

The terms fructan, glucan, Inulin and polysaccharide, respectively, as used herein also encompasses reduced, hydroxyalkylated, carboxymethylated and/or oxidized fructan, glucan, inulin and polysaccharide, respectively.

The term “inulin” as used herein is a sub-group of fructans and refers to a heterogeneous collection of fructose polymers. It consists of chain-terminating glucosyl moieties and a repetitive fructosyl moiety, which are usually linked by β(2,1) bonds. Usually, the degree of polymerization (DP) of standard inulin ranges from 2 to 100 polymerized mono units in particular from 2 to 60. An inulin compound as used herein can be modified as described above for fructans or below under the definition for a “cationic” compound as used herein.

The term “polyzwitterion” as used herein refers to any polymer which has at least one cationic and one anionic group. Usually, in polyzwitterions, the charges may be located either on the pendent side chains of different monomer units or the same monomer unit, or in the case of, e.g, some polyesters, polyphosphazenes, and polyphosphobetaines, one or both of the charges may be located along the polymer backbone.

The term “polymer” is well known in the art. As used herein, it refers to one or more than one macromolecules. A macromolecule is a molecule built of at least three monomers such as 3 to 1.000.000 monomer units. Examples of polymers are, e.g. polysaccharide, polystyrene, proteins etc.

The term “preceded by a carbonyl group” in combination with the definition of “A” means that a carbonyl group (C(O)) is located between the alkylene group and the atom of the polysaccharide compound to which A is attached.

“Reduced” polysaccharides, fructans, glucans or inulins are polysaccharides, fructans, glucans or inulins in which reducing terminal groups (usually fructose groups for fructans, glucose for glucans) have been reduced, for example using sodium borohydride or using hydrogen in the presence of a transition metal catalyst. Furthermore, “hydroxyalkylated, carboxymethylated and oxidized” polysaccharides, fructans, glucans or inulins can also serve as the basis for cationic compounds. Hydroxyalkylated and carboxymethylated polysaccharides, fructans, glucans or inulins can, e.g., be easily obtained by reaction of the respective polysaccharide with, respectively, ethylene oxide or another alkylene oxide (see, e.g., EP 0 638 589) and chloroacetic acid, preferably in an aqueous medium with a base. Oxidized polysaccharides (such as fructans, glucans or inulins) are polysaccharides which have been converted by treatment with, for example, hypochlorite or periodate and/or chlorite into compounds which contain carboxyl and/or aldehyde groups.

The skilled person is well aware of methods of the art to modify a polysaccharide (such as a fructan, including inulin or a glucan) to prepare a reduced, hydroxyalkylated, carboxymethylated and/or oxidized polysaccharide.

If not explicitly mentioned otherwise herein, ratios and percentages (%) refer to weight ratios and weight percentages, respectively. The terms “wt-%”, “wt. %”, “% (w/w)” or “weight percentages” can be used interchangeably, herein.

### DETAILED DESCRIPTION

Accordingly, one aspect refers to a composition comprising
a) at least one cationic polysaccharide compound selected from the group consisting of a cationic fructan or cationic glucan, especially preferred an inulin, which contains, per monosaccharide unit, on average at least 0.1 cationic group of the formula (I):

*-A-N⁺R¹R²R³; or
of the formula (II)

*—(C(═NR⁴)—NR¹R²R³)⁺
wherein:
*- represents the bond between an atom of the polysaccharide compound of the cationic polysaccharide compound and the cationic group of formula (I) or (II), respectively;
A in formula (I) represents a straight-chain or branched C₂-C₆ alkylene group which is optionally preceded by a carbonyl group or optionally interrupted by one or two oxygen atoms or imino or alkylimino groups and optionally substituted by one or two hydroxy groups or amine groups or a carboxyl or carbamoyl group, preferably substituted by one hydroxy group; or A represents the residue of a monosaccharide unit;
preferably a residue of a monosaccharide unit is a residue of a C5, C6, C7 or C8 monosaccharide unit, more preferably a glucose residue or a fructose residue.

R¹ and R² in formula (I) or formula (II), respectively, each represent independently from each other hydrogen methyl, carboxymethyl, phosphonomethyl, ethyl, hydroxyethyl, propyl, isopropyl, allyl, hydroxypropyl or dihydroxypropyl or, together with the nitrogen atom, form a pyrrolidino, piperidino, piperazino, N′-alkylpiperazino, N′-(hydroxyalkyl)piperazino, N′-(aminoalkyl)piperazino, morpholino or a hexamethyleneamino group;
R³ in formula (I) or in formula (II), respectively represents hydrogen, C₁-C₁₈ alkyl, C₃-C₁₈ alkenyl, alkynyl or cycloalkyl, C₄-C₁₈ cycloalkyl-alkyl or C₇-C₁₈ aralkyl; or
R³ in formula (I) represents a group of the formula -A′-Fruc, wherein A′ represents a straight-chain or branched C₂-C₆ alkylene group which is optionally preceded by a carbonyl group or optionally interrupted by one or two oxygen atoms or imino or alkylimino groups and optionally substituted by one or two hydroxy groups or amine groups or a carboxyl or carbamoyl group; or A′ represents a direct bond to Fruc wherein Fruc represents a fructan residue bonded via oxygen; and
R⁴ in formula (II) represents hydrogen, methyl, ethyl, hydroxyethyl, hydroxypropyl or dihydroxypropyl; where the amine nitrogen atoms can be uncharged or protonated or quarternized with methyl, ethyl, hydroxyethyl, hydroxypropyl or dihydroxypropyl; and
wherein the polysaccharide compound has a solubility in water of at least 20% (w/w) at a temperature of 25° C.;
b) an anionic surfactant; and
c) a compatibilizer.

Another aspect refers to the use a cationic polysaccharide compound, preferably said cationic polysaccharide compound is selected from the group consisting of a fructan or glucan, especially preferred an inulin, which contains, per monosaccharide unit, on average at least 0.1 cationic group of the formula (I):

*-A-N⁺R¹R²R³; or
of the formula (II)

*—(C(═NR⁴)—NR¹R²R³)⁺
wherein:
*-, A, R¹, R², R³ and R⁴ are as defined in the first aspect; and
wherein the polysaccharide compound has a solubility in water of at least 20% (w/w) at a temperature of 25° C.;
as larvicide against insect pests belonging to the family Culicidae.

In one preferred embodiment, the at least one cationic group in a cationic compound is a cationic group of formula (I): *-A-N⁺R¹R²R³.

In another preferred embodiment, the at least one cationic group in a cationic compound is a cationic group of formula (II): *—(C(═NR⁴)—N⁺R¹R²R³)⁺.

### Polysaccharide

In a preferred embodiment of the invention the cationic polysaccharide compounds have an average chain length (=degree of polymerization, DP) of at least 3 up to about 1.000, more preferably from 3 up to about 60. Even more preferred, the average chain length is from 3 to 30 such as from 3 to 25, from 8 to 25, from 3 to 15 or from 8 to 15 monosaccharide units.

In another preferred embodiment, the cationic polysaccharide compound is a cationic fructan compound.

Preferably, the fructan as used according to the invention contains predominantly β-2,1 bonds.

More preferably, a fructan is inulin. Inulin can be obtained from, for example, chicory, dahlias and Jerusalem artichokes.

In one preferred embodiment, a fructan, preferably inulin, or glucan is a reduced fructan, preferably reduced inulin; or reduced glucan.

In one preferred embodiment, a fructan, preferably inulin, or glucan is a hydroxyalkylated fructan, preferably inulin, or glucan, respectively.

In one preferred embodiment, a fructan, preferably inulin, or glucan is a carboxymethylated fructan, preferably inulin, or glucan, respectively.

In one preferred embodiment, a fructan, preferably inulin, or glucan is an oxidized fructan, preferably inulin, or glucan, respectively.

In another preferred embodiment, a cationic polysaccharide compound is a cationic glucan.

### A

In one preferred embodiment, A represents a straight-chain or branched C₂-C₆ alkylene group which is optionally preceded by a carbonyl group or optionally interrupted by one or two oxygen atoms or imino or alkylimino groups and optionally substituted by one or two hydroxy groups or amine groups or a carboxyl or carbamoyl group.

Preferred examples of A representing a straight-chain or branched C₂-C₆ alkylene group which is optionally preceded by a carbonyl group or optionally interrupted by one or two oxygen atoms or imino or alkylimino groups and optionally substituted by one or two hydroxy groups or amine groups or a carboxyl or carbamoyl group are ethylene, 1,2- or 1,3-propylene, 2-hydroxy-1,3-propylene, 1,2- or 1,3- or 1,4- or 2,3-tetramethylene, 1,2- or 1,3- or 1,4- or 1,5- or 1,6- or 2,3- or 2,4- or 2,5- or 3,4-hexamethylene, 2,2-dimethyl-1,3-propylene, 1,2- or 1,3- or 1,4- or 2,3-butenylene, 1,2- or 1,3- or 1,4-cyclohexylene, N-methyliminodiethylene, diiminotriethylene, oxydiethylene, oxydipropylene, ethyleneiminocarbonylmethylene, carbonylethylene and carboxyethylene.

Compounds containing a 3-aminopropyl group or a 3-carboxymethyl-aminopropyl group also form part of the invention. Such compounds have been described in WO 96/34017 and WO 98/06756.

In another preferred embodiment, A represents a straight-chain or branched C₂-C₆ alkylene group which is preceded by a carbonyl group (i.e. polysaccharide-C(O)—(C₂-C₆)-alkylene, *—C(O)—(C₂-C₆)-alkylene, wherein *- represents the bond between an atom of the polysaccharide compound of the cationic polysaccharide compound and the cationic group of formula (I) or (II), respectively).

In yet another preferred embodiment, A represents a straight-chain or branched C₂-C₆ alkylene group which is substituted by one or two hydroxy groups.

In yet another preferred embodiment, A represents a straight-chain C₂-C₆ alkylene group which is substituted by one hydroxy group.

In a more preferred embodiment, “A” represents a 2-hydroxy-1,3-propylene group:

—CH₂—C(OH)H—CH₂—

In yet another preferred embodiment, A represents a monosaccharide unit, preferably selected from the group consisting of a C5, C6, C7 or C8 monosaccharide unit, more preferably selected from the group consisting of glucosyl and fructosyl.

In a preferred embodiment of the invention relates to the above-described cationic polysaccharide compounds, wherein “A” is bonded to an oxygen atom of the polysaccharide (e.g., glucan, fructan or inulin).

A further preferred embodiment relates to a cationic polysaccharide compound, wherein the polysaccharide compound comprises a cationic group of formula (I) wherein A represents ethylene or 2-hydroxypropylene.

R¹, R² and R³

Another preferred embodiment relates to the above-described cationic polysaccharide compound, wherein the cationic polysaccharide compound comprises a cationic group of formula (I) (-A-N⁺R¹R²R³) wherein:

In a preferred embodiment, R¹ and R² in formula (I) each represent methyl or ethyl.

In a further preferred embodiment, R³ in formula (I) represents H.

In a further preferred embodiment, R³ in formula (I) represents methyl.

In a further preferred embodiment, R³ in formula (I) represents ethyl.

In a further preferred embodiment, R¹ and R² in formula (I) each represent methyl and R³ represents H.

In a further preferred embodiment, R¹, R² and R³ in formula (I) each represent methyl or ethyl.

In yet another preferred embodiment, R¹, R² and R³ in formula (I) each represent methyl.

In yet another preferred embodiment two moieties of R¹, R² and R³ in formula (I) represent methyl and the third moiety represents ethyl.

In yet another preferred embodiment, R¹, R² and R³ in formula (I) each represent ethyl.

Another preferred embodiment relates to the above-described cationic polysaccharide compound, wherein the cationic polysaccharide compound comprises a cationic group of formula (II) (—(C(═NR)—NR¹R²R³)⁺) wherein:

In a preferred embodiment, R¹ and R² in formula (II) each represent methyl or ethyl.

In a further preferred embodiment, R³ in formula (II) represents H.

In a further preferred embodiment, R³ in formula (II) represents methyl.

In a further preferred embodiment, R³ in formula (II) represents ethyl.

In a further preferred embodiment, R¹ and R² in formula (II) each represent methyl and R³ represents H.

In a further preferred embodiment, R¹, R² and R³ in formula (II) each represent methyl or ethyl.

In yet another preferred embodiment, R¹, R² and R³ in formula (II) each represent methyl.

In yet another preferred embodiment two moieties of R¹, R² and R in formula (II) represent methyl and the third moiety represents ethyl.

In yet another preferred embodiment, R¹, R² and R³ in formula (II) each represent ethyl.

### R⁴

Another preferred embodiment relates to the above-described cationic polysaccharide compound, wherein the cationic polysaccharide compound comprises a cationic group of formula (II) (—(C(═NR⁴)—NR¹R²R³)⁺) wherein:

In one preferred embodiment, R⁴ is H.

In another preferred embodiment, R⁴ is methyl.

In yet another preferred embodiment, R⁴ is ethyl.

In a further preferred embodiment, R⁴ is H and R¹ and R² in formula (II) each represent methyl or ethyl.

In a further preferred embodiment, R⁴ is H and R¹ and R² in formula (II) each represent methyl.

In a further preferred embodiment, R⁴ is H and R¹ and R² in formula (II) each represent ethyl.

In a further preferred embodiment, R⁴ is methyl and R¹ and R² in formula (II) each represent methyl or ethyl.

In a further preferred embodiment, R⁴ is methyl and R¹ and R² in formula (II) each represent methyl.

In a further preferred embodiment, R⁴ is methyl and R¹ and R² in formula (II) each represent ethyl.

In a further preferred embodiment, R⁴ is ethyl and R¹ and R² in formula (II) each represent methyl or ethyl.

In a further preferred embodiment, R⁴ is ethyl and R¹ and R² in formula (II) each represent methyl.

In a further preferred embodiment, R⁴ is ethyl and R¹ and R² in formula (II) each represent ethyl.

In a further preferred embodiment, R¹ and R² in formula (II) each represent methyl and R represents H and R⁴ represents H.

In a further preferred embodiment, R¹, R² and R in formula (II) each represent methyl or ethyl and R⁴ represents H.

In yet another preferred embodiment, R¹, R² and R³ in formula (II) each represent methyl and R⁴ represents H.

In yet another preferred embodiment two moieties of R¹, R² and R³ in formula (II) represent methyl and the third moiety represents ethyl and R⁴ represents H.

In yet another preferred embodiment, R¹, R² and R³ in formula (II) each represent ethyl and R⁴ represents H.

In a further preferred embodiment, R¹ and R² in formula (II) each represent methyl and R³ represents H and R⁴ represents methyl.

In a further preferred embodiment, R¹, R² and R³ in formula (II) each represent methyl or ethyl and R⁴ represents methyl.

In yet another preferred embodiment, R¹, R² and R³ in formula (II) each represent methyl and R⁴ represents methyl.

In yet another preferred embodiment two moieties of R¹, R² and R³ in formula (II) represent methyl and the third moiety represents ethyl and R⁴ represents methyl.

In yet another preferred embodiment, R¹, R² and R³ in formula (II) each represent ethyl and R⁴ represents methyl.

In a further preferred embodiment, R¹ and R² in formula (II) each represent methyl and R³ represents H and R⁴ represents ethyl.

In a further preferred embodiment, R¹, R² and R³ in formula (II) each represent methyl or ethyl and R⁴ represents ethyl.

In yet another preferred embodiment, R¹, R² and R³ in formula (II) each represent methyl and R⁴ represents ethyl.

In yet another preferred embodiment two moieties of R¹, R² and R³ in formula (II) represent methyl and the third moiety represents ethyl and R⁴ represents ethyl.

In yet another preferred embodiment, R¹, R² and R³ in formula (II) each represent ethyl and R⁴ represents ethyl.

Degree of Substitution (DS) of Polysaccharide Compounds with Cationic Groups

Another embodiment of the invention relates to the above-described cationic polysaccharide compound which preferably contains, per monosaccharide unit, on average at least 0.1 cationic group, preferably degree of substitution (DS) between 0.1 to 2.5 and more preferably on average 0.5 to 1.5 cationic group. However, the skilled person is aware that, irrespective of the chain length of a cationic polysaccharide compound, the amount of a cationic group in a cationic polysaccharide compound is at least 1.

In one preferred embodiment, the DS is between 0.2 and 0.5; such as between 0.2 and 0.5 or between 0.25 and 0.45.

In another more preferred embodiment, the DS is between 0.5 and 0.8; such as between 0.55 and 0.75.

In yet another even more preferred embodiment, the DS is between 0.9 and 1.7; such as between 1.0 and 1.6 or between 1.1 and 1.6.

### Cationic Polysaccharides

Cationic polysaccharide compounds are commercially available. Therefore, in a further preferred embodiment of the invention, the cationic polysaccharide is a hydroxypropyl trimonium inulin (205131-94-8) for example as branded under the Quatin product series by Cosun (Cosun Beet Company—Biobased Experts B.V.), wherein Trimonium is a synonym for trimethylammonium chloride. Cosun offers several Quatin products characterized by different (average) degree of substitution (DS), as Quatin 350 TQ-D (DS 0.3-0.4), active content around 40 w %), Quatin 680 TQ-D (DS 0.63-0.73), active content around 40 w %) and Quatin 1280 TQ-D (DS 1.18-1.38, active content around 30 w %). Also offered are ultra-pure (UP) qualities with a reduced content of by-products and sodium chloride like Quatin 680 UP-D.

### Definition of the Shortcut “*-”

Although cationic polysaccharide compounds are commercially available, the skilled person can also prepare such compounds easily with standard synthesis steps, e.g., as described above.

Generally, a cationic group can be attached via a carbon-carbon bond or a carbon-oxygen bond to a polysaccharide compound to form a cationic polysaccharide compound. Preferably *- is a bond to an oxygen (which is attached to a carbon of a polysaccharide compound). Thus, instead of a hydroxyl group (—OH), a cationic polysaccharide compound comprises a —O-cationic group of formula (I) or formula (II) group, respectively. The skilled person understands that it is irrelevant if an oxygen derived from the polysaccharide compound or the educt/precursor of the cationic group forming the cationic polysaccharide compound. E.g., if a cationic group of formula (I) is bound to a polysaccharide compound via an oxygen (polysaccharide-O-A-N⁺R¹R²R³), such a structure can, for example, be achieved by an esterification of a —OH group of the polysaccharide compound with an acid group of a educt/precursor of the cationic group (e.g. COOH—CH₂CH₂—N⁺R¹R²R³) resulting in a cationic polysaccharide compound (polysaccharide-O—C(O)—CH₂CH₂—N⁺R¹R²R³), wherein A is a C₂-C₆ alkylene group which is preceded by a carbonyl group. The skilled person is aware that the oxygen in the ester is usually derived from the hydroxyl function; however, such a structure can, for example, also be achieved by an ether formation (of two hydroxy groups), i.e. in such a case the oxygen in the ether could derive from either alcoholic function. Nevertheless, in the resulting ester or ether, respectively, a hydrogen of a hydroxy group is formally substituted by a cationic group when comparing the polysaccharide educt with the cationic polysaccharide product.

### Anionic Surfactant (b) in the Formulation

The formulations according to the invention comprises next to the cationic polysaccharide (a), at least one anionic surfactant (b).

In one preferred embodiment, an anionic surfactant is an organic compound comprising at least one non-polar part (aliphatic chain) and as a polar part one or more negatively charged groups, preferably selected from the group consisting of carboxylate (—COO⁻), sulfonate (—SO₃⁻) and sulfate (—SO₄²⁻) group.

Thus, in one preferred embodiment, an anionic surfactant is selected from the group consisting of alkylsulphonates, arylsulphonates, alkylarylsulphonates, aryl ether sulphonates, lignosulphonates, alkyl sulphates, alkyl ether sulphates, sulphosuccinates, aliphatic and aromatic phosphate esters, alkoxylated phosphate esters, alkylcarboxylates (preferably fatty acids), polycarboxylates, and salts of any of the foregoing.

Preferably, the anionic surfactant is a salt of an alkylsulphonate, an arylsulphonate, an alkylarylsulphonate, an aryl ether sulphonate, a lignosulphonate, an alkyl sulphate, an alkyl ether sulphate, a sulphosuccinate, an aliphatic and aromatic phosphate ester, an alkoxylated phosphate ester, an alkylcarboxylate (preferably a fatty acid) or a polycarboxylate.

Preferably the salt is an alkaline or an alkaline earth metal salt, even more preferably a calcium salt, a potassium salt, or a sodium salt.

In another preferred embodiment, the anionic surfactant is a fatty acid (preferably a salt thereof, as described above).

In yet another preferred embodiment, the number of carbons of an aliphatic chain of a fatty acid is between 4 and 40.

Surface-active fatty acids, which are biodegradable and preferably also bio-based, can be used as alternatives to the use of an anionic surfactant in the present invention. Depending on the pH and composition of the larvicidal formulation, the selected fatty acids will partially or completely deprotonate to form anionic fatty acid salts.

Various fatty acids may be selected from the group consisting of caprylic acid, pelargonic acid, capric acid, undecanoic acid, 10-undecanoic acid, lauric acid, myristic acid, palmitic acid, oleic acid, and mixtures thereof. Other fatty acid mixtures such as soybean fatty acids and coconut fatty acids and other naturally occurring fatty acid mixtures may also form the fatty acid component of the larvicidal formulation of the invention. Both free fatty acids and their salt-form, preferably water-soluble sodium, potassium, or ammonium fatty acid salts, can be selected.

In a preferred embodiment of the invention, pelargonic acids such as Emerion™ W90 PA TG and Emery 1203 (Emery Oleochemicals) or oleic acid mixtures such as Edenor Ti 05 (Caldic) are being used.

In another preferred embodiment, an anionic surfactant is a sulphosuccinate (or a salt thereof), more preferably the anionic surfactant is sodium dioctyl sulphosuccinates like Geropon® DOS-PG (Solvay) or Aerosol® OT 70PG (Cytec).

### Compatibilizer (c) in the Formulation

Upon combination of cationic fructan or glucan, preferably an inulin, with an anionic surfactant, preferably a fatty acid or a mixture of fatty acids, formulation measures are necessary to prevent physical incompatibility and irreversible precipitation and to enable easy handling and effective application.

Therefore, a formulation according to the present invention further comprises a compatibilizer. Preferably, the compatibilizer is selected from the group of amphoteric polymers, wherein the amphoteric polymers, for clarification's sake, which are different from the cationic polysaccharide compounds of the invention.

Amphoteric polymers contain anionic and cationic groups in the molecule, which charge properties may be pH dependent. Examples of synthetic amphoteric polymers are 4-vinylpyridine-co-acrylic acid, N,N-dimethylaminoethylmethacrylate-co-methacrylic acid, N-vinylimidazole-co-acrylic acid, N—N′-dimethyl-N,N′-diallylammonium chloride-co-acrylic acid, sodium styrene sulfonate-co-4-vinylpyridine, Poly(carbobetaine), Poly(sulfobetaine), Poly(phosphobetaine) or amphoteric proteins, such as amphoteric proteins from vegetable and cereal sources (e.g., soy, potato and pea protein), milk proteins (Eg. caseins and whey proteins) and collagen.

Industrially, these proteins are isolated by different extraction and processing techniques to obtain technical protein mixtures with different degrees of by-products. Protein isolates Eg. are technical protein mixtures with a reduced lipids and carbohydrates content. Potato protein commercialized under the brand name Solanic® by Avebe provides an example of a technical protein mixture.

In a preferred embodiment of the present invention, amphoteric proteins or technical and/or processed protein mixtures are being used which are water-soluble or soluble in aqueous solutions, having an isoelectric point between 3 and 9, or more preferred between 4 and 7. In one preferred embodiment, a amphoteric protein is selected from the group consisting of whey protein (preferably casein), potato protein (preferably patatin (a family of glycoproteins found in potatoes)), soy protein, hydrolyzed collagen, native collagen, and albumin.

In an even more preferred embodiment of the invention, the compatibilizer is selected from the group of hydrolyzed proteins which are soluble in aqueous phases, especially hydrolyzed collagens. Hydrolyzed collagen is a polypeptide composite made by hydrolysis of denatured native collagen or gelatin. It is also called collagen hydrolysate, collagen peptide, hydrolyzed gelatin, or gelatin hydrolysate. The molecular weights of hydrolyzed collagen (e.g. Novatec CB800) are within the range of approximately 500-25000 Da with an isoelectric point between and 9. More preferred are hydrolyzed collagens with a molecular weight below 10 kD and an isoelectric point between 5 and 7.

pH

In a preferred embodiment, the pH of a composition according to the invention is above the isoelectric point of an anionic surfactant. The skilled person will understand that the isoelectric point of a substance can varies depending on the nature of an anionic surfactant.

In one preferred embodiment, the pH of a composition according to the invention is between 4 and 9. In a more preferred embodiment, the pH is between 4 bis 8.5; even more preferred between 4.5 and 8.5.

### Uses

The invention further relates to the use of the composition of the invention, or a cationic polysaccharide compound as described herein to curatively or preventively control larvae of insect pests, preferably belonging to the family Culicidae, more preferably of the subfamily Anophelinae and Culicinae. Thus, one aspect refers to the use of a composition according to the invention or the cationic polysaccharide compound as described herein in resistance management of insect pests, preferably belonging to the family of Culicidae.

In one embodiment, a cationic polysaccharide compound as described herein (preferably in form of a formulation according to the invention) is applied to larvae of said insect pest.

In another embodiment, a cationic polysaccharide compound is applied to larvae of said insect pest via a direct spray application.

One aspect further refers to a method to control larvae of insect pests, preferably of the family Culicidae, comprising applying a composition according to the invention or a cationic polysaccharide compound as described herein to larvae of an insect pest or a crop where said larvae are located or expected to be located.

It is likely that above-described discoveries are related to the charge compensation of these (partial) oppositely charged molecules to build supramolecular complexes. Hence, it might be anticipated that the discovered principle to boost biological performance can be transferred to other charged oligomers or polymers with intrinsic larvicidal properties, like Eg. certain RNAi species.

In summary, with this invention it has surprisingly been found that formulations containing (a) one or more cationic inulin and optionally (b) one or anionic surfactants or fatty acids and (c) a compatibilizer exhibit excellent efficacy against mosquito larvae.

As a further advantage, the larvicidal formulations of the invention (and diluted aqueous composition thereof) are bio-based, easy-to-produce and easy-to-handle. Based on the underlying chemistry, it is expected that mosquitos will not be able to develop resistance against this invention, which therefore may represent a new tool for resistance management.

### EXAMPLES

As a cationic polysaccharide as used in the experiments described below Quatin 680 in various grades (CAS 205131-94-8) was used. Quatin 680 is a hydroxypropyltrimonium inulin.

As an anionic surfactant, Geropon DOS-PG (a sulfosuccinate) or EMERY 1203A (pelargonic acid (nonanoic acid)).

Synergen W06 (fatty alcohol alkoxylate) and Break Thru S 240 (polyether trisiloxane) were used as nonionic surfactants.

As compatibilizers, Gelita Novotec CB800 (aqueous gelatin hydrolysate solution, 55 w/w % active matter) and Lucramul CO30 (castor oil ethoxylate, 100% active matter, a nonionic surfactant, LEVACO Chemicals GmbH) were tested.

### Example 1

Preparation of cationic inulin formulations containing an anionic surfactant and a compatibilizer according to the Invention (A) and comparative formulations (B) and (C).

Cationic inulin formulations were prepared having the following compositions and pH values:

| | Batch | | |
|---|---|---|---|
| | A | B | C |
| | % (w/w) | % (w/w) | % (w/w) |
| Quatin 680 TQ-D (cationic inulin) | 60 | 60 | 60 |
| Gelita Novotec CB800 | 30 | 0 | 0 |
| (compatibilizer, 55 w/w %) | | | |
| Lucramul CO30 (100 w/w %) | 0 | 0 | 16.5 |
| Geropon DOS-PG (anionic | 10 | 10 | 10 |
| surfactant) | | | |
| Demineralized water | 0 | 30 | 13.5 |
| pH value | 8.0 | 8.0 | 8.0 |

If required, the pH was adjusted with diluted hydrochloric acid or potassium hydroxide

Both samples were produced by mixing all components and adjusting the pH value using diluted solutions of either hydrochloric acid or sodium hydroxide. The pH values were adjusted with a tolerance of 0.2 pH units.

After manufacturing, both samples were put at rest over 24 h at ambient conditions. After this period, sample A did show no significant phase separation. In comparison, Samples B and C showed a clear phase separation, with an upper clear phase representing roughly 20% of the total sample volume. These phase-separated samples B and C could be easily re-homogenized by shaking. However, after subsequent 5 min resting time, significant phase separation could be observed, again.

This example shows that an amphoteric compound can be used as a compatibilizer to enable the formulation of homogeneous mixtures containing both a cationic polysaccharide compound (e.g. Quatin 680) and an anionic surfactant (e.g. Geropon DOS-PG).

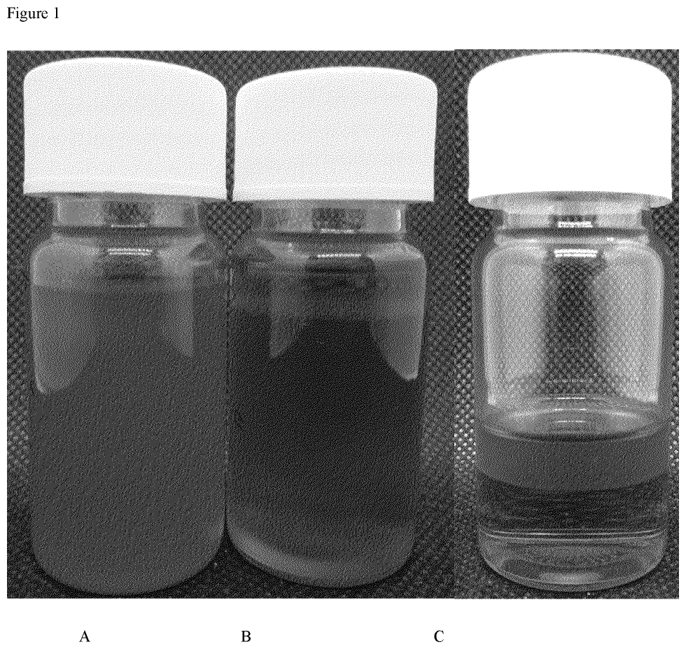

FIG. 1 shows the black/white picture of the three samples after 24 h. Phase separation can be observed in Sample B and C, respectively. In case this is not visible by the black/white pictures, the same pictures can be provided as colored pictures upon request.

### Example 2

Preparation of cationic inulin formulations containing a fatty acid and a compatibilizer according to the Invention (D) and comparative formulations (E).

Cationic inulin formulations were prepared having the following compositions and pH values:

| | Batch | |
|---|---|---|
| | D | E |
| | % (w/w) | % (w/w) |
| Quatin 680 TQ-D (cationic inulin) | 30.00 | 30.00 |
| GELITA NOVOTEC CB800 (Compatibilizer) | 15.00 | 0.00 |
| Nonanoic acid TC (anionic surfactant) | 2.25 | 2.25 |
| Citric acid anhydrous | 0.09 | 0.09 |
| Potassium hydroxide 45% (KOH) | 2.62 | 2.62 |
| DEMINERALISED WATER | 50.04 | 65.04 |
| pH | 8.0 | 8.0 |

Both formulations were produced according to following procedure: Mix Quatin 680 TQ-D with Novotec CB 800 with 50% of total water amount and add 25% of total amount of 45% KOH solution and homogenize to obtain a Quatin premix.

Mix nonanoic acid with 10% of total water amount with remaining amount of 45% KOH solution to obtain a nonanoic acid premix Combine Quatin premix with nonanoic premix and homogenize Adjust pH of resulting mixture with diluted solutions of citric acid or potassium hydroxide with a tolerance of 0.2 pH units. Add remaining amount of water and homogenize again. The pH values were adjusted.

After preparation and resting for 24 h under ambient conditions, sample D containing Novotec CB 800 shows a clear homogeneous solution. In comparison, Sample E without Novotec CB 800 shows a transparent solution containing small precipitates, which sediment overtime. By shaking vigorously, these precipitates do not redissolve again.

Hence, this example shows that Novotec CB 800 can be used as a compatibilizer enabling homogeneous formulations containing both Quatin 680 and nonanoic acid. Due to the composition's pH of 8.0 (above the isoelectric point of the nonanoic acid) the nonanoic acid will be present mainly in its potassium salt or anionic form.

### Bioassay Method

Aedes aegypti Larvicide Test (AEDSAE Larvicide Assay)

To produce an active ingredient containing solution it is necessary to solve the test compound/formulation in 100 mL water achieving the desired final concentration. Second and third instar larvae of the species Aedes aegypti are placed into the solution. Treatment of larvae with water (without active ingredient) serves as negative control. Biological efficacy is determined and reported in percent mortality (%) over several days, as indicated. 100% mortality means that all tested insects are dead, whereas 0% means that no insect died.

### BIO EXAMPLES

### Bio-Example 1: Bio-Efficacy of Different Cationic Polysaccharide Compounds

TABLE 1
Formulation of different types.

| | Batch number | | |
|---|---|---|---|
| | F | G | H |
| Material name | % (w/w) | % (w/w) | % (w/w) |
| QUATIN 350 TQ-D | 50 | 0 | 0 |
| QUATIN 680 TQ-D | 0 | 50 | 0 |
| QUATIN 1280 TQ-D | 0 | 0 | 50 |
| DEMINERALISED | 50 | 50 | 50 |
| WATER | | | |
| pH value | 5.6 | 5.4 | 4.9 |

TABLE 2
Bio-efficacy in demineralized water at using different types.

| batch | conc | | | | | |
|---|---|---|---|---|---|---|
| number | Quatin | day 1 | day 2 | day 3 | day 4 | day 7 |
| F | 0.5% | 0 | 0 | 66.7 | 66.7 | 66.7 |
| G | 0.05% | 0 | 16.7 | 50 | 100 | 100 |
| H | 0.05% | 16.7 | 33.3 | 66.7 | 83.3 | 100 |

Data presented in table 2 represent mean values from technical triplicates of mosquito larvae mortality in percent observed over 7 days after application of the indicated formulation. No dead larvae or pupae were recorded from negative control samples. The conc Quatin is the Quatin application rate, i.e. the concentration of Quatin in the aqueous solution of the bio-assay.

### Bio-Example 2: Bio Efficacy of Quatin 680 and its Formulation of Invention

TABLE 3
Different Quatin formulations.

| | Batch number | | | |
|---|---|---|---|---|
| | I | J | K | L |
| Material name | % w/w | % w/w | % w/w | % w/w |
| Quatin 680 TQ-D | 50 | 50 | 50 | 0 |
| GELITA NOVOTEC | 45 | 45 | 0 | 45 |
| CB800 (Compatibilizer) | | | | |
| GEROPON DOS-PG | 5 | 0 | 0 | 5 |
| (anionic surfactant) | | | | |
| DEMINERALISED | 0 | 5 | 50 | 50 |
| WATER | | | | |
| pH value | 5.2 | 5.1 | 5.4 | 5.2 |

TABLE 4
Bio-efficacy in demineralized water at using different Quatin formulations.

| batch | | conc. | | | | | | |
|---|---|---|---|---|---|---|---|---|
| number | Quatin type | Quatin | day 1 | day 2 | day 3 | day 6 | day 7 | day 14 |
| K | Quatin 680 | 0.005% | 0 | 10 | 10 | 60 | 90 | 100 |
| | TQ-D | | | | | | | |
| J | Quatin 680 | 0.005% | 0 | 30 | 50 | 90 | 90 | 100 |
| | TQ-D | | | | | | | |
| I | Quatin 680 | 0.005% | 60 | 90 | 100 | 100 | 100 | 100 |
| | TQ-D | | | | | | | |
| L | — | 0% | 0 | 0 | 0 | 0 | 0 | 0 |

Data presented in table 4 represent mean values from 2 technical replicates of mosquito larvae mortality in percent observed over 14 days after application of the indicated formulation. No dead larvae or pupae were recorded from negative control and blank formulation (K) samples.

### Bio-Example 3: Evaluation of the Impact of Surfactant on Bio Efficacy

TABLE 5
Quatin 680 UP-D formulations with different surfactants.

| | Batch | | | |
|---|---|---|---|---|
| | M | N | O | P |
| Material name | % w/w | % w/w | % w/w | % w/w |
| Quatin 680 UP-D | 60 | 60 | 60 | 60 |
| Gelita Novotec CB 800 | 30 | 30 | 30 | 30 |
| (compatibilizer) | | | | |
| Geropon DOS PG (anionic | 0 | 10 | 0 | 0 |
| surfactant) | | | | |
| Synergen W06 (non-ionic | 0 | 0 | 10 | 0 |
| surfactant) | | | | |
| Break Thru S 240 (non- | 0 | 0 | 0 | 1 |
| ionic surfactant) | | | | |
| DEMINERALISED | 10 | 0 | 0 | 9 |
| WATER | | | | |
| pH value | 5.0 | 5.0 | 5.1 | 5.0 |

TABLE 6
Bio-efficacy in demineralized water at using Quatin
formulations with different surfactants.

| batch | Conc. | | | | | | | | |
|---|---|---|---|---|---|---|---|---|---|
| number | Quatin | day 1 | day 2 | day 3 | day 6 | Day 7 | day 9 | day 10 | day 13 |
| M | 0.006% | 3 | 3 | 10 | 57 | 83 | 97 | 97 | 100 |
| N | 0.006% | 90 | 93 | 97 | 100 | 100 | 100 | 100 | 100 |
| O | 0.006% | 0 | 0 | 13 | 40 | 80 | 90 | 93 | 100 |
| P | 0.006% | 0 | 7 | 13 | 67 | 80 | 93 | 97 | 100 |

Data presented in table 6 represent mean values from technical triplicates of mosquito larvae mortality in percent observed over 13 days after application of the indicated formulation. No dead larvae or pupae were recorded from negative control samples.

### Bio-Example 4: Evaluation of the Impact Water Quality on Bio-Efficacy

TABLE 7
Bio efficacy of formulations in different bio-assay water qualities.

Batch

| | Q | R |
|---|---|---|
| Material name | % w/w | % w/w |
| Quatin 680 UP-D | 60 | 60 |
| Gelita Novotec CB 800 | | |
| (compatibilizer) | 30 | 30 |
| Geropon DOS PG | | |
| (anionic surfactant) | 0 | 10 |
| Demineralized water | 10 | 0 |
| pH value | 8.0 | 8.0 |

TABLE 8
Bio-efficacy in different water qualities using Quatin formulations.

| | conc | | | | | | | | |
|---|---|---|---|---|---|---|---|---|---|
| batch | Quatin 680 | | | | | | | | |
| number | UP-D | water | day 1 | day 2 | day 3 | day 4 | day 7 | day 8 | day 9 |
| Q | 0.006% | Demineralized | 43 | 90 | 97 | 97 | 100 | 100 | 100 |
| | | water | | | | | | | |
| Q | 0.006% | Pond water* | 0 | 0 | 0 | 0 | 0 | 0 | 0 |
| R | 0.006% | Demineralized | 73 | 97 | 97 | 100 | 100 | 100 | 100 |
| | | water | | | | | | | |
| R | 0.006% | Pond water* | 0 | 67 | 77 | 80 | 80 | 80 | 80 |
| control | — | Demineralized | 0 | 0 | 0 | 0 | 0 | 0 | 0 |
| | | water | | | | | | | |
| control | — | Pond water* | 0 | 0 | 0 | 0 | 0 | 0 | 0 |

*to show the effect of naturally impurities in water in regard of the bio efficacy, water from a random pond in Monheim, Germany was used as a comparison to demineralized water.

Data presented in table 8 represent mean values from technical triplicates of mosquito larvae mortality in percent observed over 9 days after application of the indicated formulation. No dead larvae or pupae were recorded from negative control samples. Even if water contains naturally occurring organic and/or inorganic impurities, the effect on larvae can be demonstrated.

### Bio-Example 5: Use of Fatty Acid as Anionic Surfactant

TABLE 9
Formulations with fatty acids as anionic surfactants

| | S | T | U |
|---|---|---|---|
| | %(w/w) | %(w/w) | %(w/w) |
| Quatin 680 TQ-D | 30.00 | 30.00 | 0.00 |
| GELITA NOVOTEC CB800 | 15.00 | 15.00 | 15.00 |
| (compatibilizer) | | | |
| EMERY 1203A (nonanoic acid) | 2.25 | 0.00 | 2.25 |
| (anionic surfactant) | | | |
| Citric acid anhydrous (used | 0.09 | 0.00 | 0.03 |
| for pH adjustment) | | | |
| Potassium hydroxide 45% KOH | 2.62 | 0.67 | 2.62 |
| Demineralized water | 50.04 | 54.33 | 80.10 |
| pH | 8.0 | 8.0 | 8.0 |

For Tables 10 and 11, the same bioassay method as for the Aedes aegypti larvicide test (AEDSAE larvicide assay) was used but instead of Aedes aegypti, Culex quinquefasciatus, or Anopheles Funestus, respectively, were used.

TABLE 10
Bio-efficacy of various Quatin formulations

| | | Quatin 680 TQ- | cationic inulin |
|---|---|---|---|
| | FL Application rate | D Application | (solids) Application |
| | (%) | rate (%) | rate (ppm) |
| S | 0.200 | 0.060 | 240 |
| T | 0.200 | 0.060 | 240 |
| U | 0.200 | 0.000 | 0 |

TABLE 11
evaluation of the impact of fatty acids (anionic surfactants) on bio-efficacy

| % Mortality | mosquito species | 1 h | 24 h | 2 d | 3 d | 6 d | 8 d | 10 d |
|---|---|---|---|---|---|---|---|---|
| S | Aedes aegypti | 100 | 100 | 100 | 100 | | | |
| T | Aedes aegypti | 23 | 27 | 27 | 33 | 73 | 83 | 90 |
| U | Aedes aegypti | 0 | 0 | 0 | 7 | 10 | 10 | 10 |
| S | Culex quinquefasciatus | 100 | 100 | 100 | 100 | | | |
| T | Culex quinquefasciatus | 70 | 77 | 77 | 77 | 83 | 90 | 90 |
| U | Culex quinquefasciatus | 0 | 0 | 0 | 0 | 0 | 0 | 0 |
| S | Anopheles Funestus | 100 | 100 | 100 | 100 | | | |
| T | Anopheles Funestus | 0 | 50 | 70 | 73 | 100 | | |
| U | Anopheles Funestus | 0 | 0 | 0 | 27 | 73 | | |
| control | | 0 | 0 | 0 | 0 | 0 | 0 | 0 |

1. A composition comprising
a) at least one cationic polysaccharide compound selected from the group consisting of cationic fructan or cationic glucan which contains, per monosaccharide unit, on average at least 0.1 cationic group of the formula (I):
*-A-N⁺R¹R²R³; or
of the formula (II)
*—(C(═NR⁴)—NR¹R²R²R³)⁺
wherein:
*- represents the bond between an atom of the polysaccharide compound of the cationic polysaccharide compound and the cationic group of formula (I) or (II), respectively;
A in formula (I) represents a straight-chain or branched C2-C6 alkylene group which is optionally preceded by a carbonyl group or optionally interrupted by one or two oxygen atoms or imino or alkylimino groups and optionally substituted by one or two hydroxy groups or amine groups or a carboxyl or carbamoyl group; or A represents the residue of a monosaccharide unit;
R¹ and R² in formula (I) or in formula (II) each represent independently from each other hydrogen methyl, carboxymethyl, phosphonomethyl, ethyl, hydroxyethyl, propyl, isopropyl, allyl, hydroxypropyl or dihydroxypropyl or, together with the nitrogen atom, form a pyrrolidino, piperidino, piperazino, N′-alkylpiperazino, N′-(hydroxyalkyl)piperazino, N′-(aminoalkyl)piperazino, morpholino or hexamethyleneamino group;
R³ in formula (I) or in formula (II), respectively, represents hydrogen, C 1-C 18 alkyl, C3-C18 alkenyl, alkynyl or cycloalkyl (for clarification's sake: C3-C18 alkenyl, C3-C18 alkynyl or C3-C18 cycloalkyl), C4-C18 cycloalkyl-alkyl or CrC18 aralkyl; or
R³ in formula (I) represents a group of the formula -A′-Prue, wherein A′ represents a straight-chain or branched C2-C6 alkylene group which is optionally preceded by a carbonyl group or optionally interrupted by one or two oxygen atoms or imino or alkylimino groups and optionally substituted by one or two hydroxy groups or amine groups or a carboxyl or carbamoyl group; or A′ represents a direct bond to Prue wherein Prue represents a fructan residue bonded via oxygen; and
R⁴ in formula (II) represents hydrogen, methyl, ethyl, hydroxyethyl, hydroxypropyl or dihydroxypropyl; where the amine nitrogen atoms can be uncharged or protonated or quarternized with methyl, ethyl, hydroxyethyl, hydroxypropyl or dihydroxypropyl;
and wherein the polysaccharide compound has a solubility in water of at least 20 wt-% at a temperature of 25° C.;
b) an anionic surfactant; and
c) a compatibilizer, selected from the group consisting of amphoteric polymer and polyzwitterion.

2. A method of using at least one cationic polysaccharide compound selected from the group consisting of cationic fructan or cationic glucan which contains, per monosaccharide unit, on average at least 0.1 cationic group of the formula (I):
-A-N⁺R¹R²R³; or
of the formula (II)
—(C(═NR⁴)—NR¹R²R²R³)⁺
wherein *-, A, R¹, R², R³, and R⁴ are as defined in claim 1 and wherein the polysaccharide
compound has a solubility in water of at least 20 wt-% at a temperature of 25° C.; as larvicide against insect pests belonging to the family Culicidae.

3. The composition according to claim 1, wherein the cationic polysaccharide compound is cationic fructan.

4. The composition according to claim 1, wherein the cationic fructan compound is inulin.

5. The composition according to claim 1, wherein R1 and R2 in formula (I) or formula (II), respectively, each represent methyl or ethyl.

6. The composition according to claim 1, wherein R¹ and R² and R³ in formula (I) represent methyl.

7. The composition according to claim 1, wherein A in formula (I) represents a C2-C6 alkylene group which is optionally substituted by a hydroxy group.

8. The composition according to claim 1, wherein A in formula (I) represents ethylene or (1,3)-2-hydroxy-propylene.

9. The composition according to claim 1, wherein A is bonded to an oxygen atom of the monosaccharide unit.

10. The composition according to claim 1, wherein the cationic polysaccharide compound contains, per monosaccharide unit, on average from 0.1 to 2.5, optionally on average from 0.2 to 2.0 and optionally from 0.35 to 1.5 cationic group.

11. The composition according to claim 1, wherein the cationic polysaccharide compound has a degree of polymerization from 3 to 1000, preferably from 3 to 60 and optionally from 3 to 15 monosaccharide units.

12. The composition according to claim 1, wherein said anionic surfactant is selected from the group consisting of alkylsulphonates, arylsulphonates, alkylarylsulphonates, aryl ether sulphonates, lignosulphonates, alkyl sulphates, alkyl ether sulphates, sulphosuccinates, aliphatic and aromatic phosphate esters, alkoxylated phosphate esters, alkylcarboxylates, polycarboxylates, and salts of any of the foregoing.

13. The composition according to claim 1, wherein said anionic surfactant is a sodium dioctyl sulphosuccinate.

14. The composition according to claim 1, wherein said compatibilizer is hydrolysed collagen.

15. A product comprising the composition according to claim 1, to curatively or preventively control larvae of insect pests, optionally belonging to the family Culicidae, optionally of the subfamily Anophelinae and Culicinae.
